(19) United States
(12) Patent Application Publication
(10) Pub. No.: US 2010/0260885 A1
(43) Pub. Date: Oct. 14, 2010

(54) IMPRINTING APPARATUS

(75) Inventors: Ryouichi TAKAHASHI, Yokosuka-shi (JP); Satoshi SHIROTORI, Yokohama-shi (JP); Tsuyoshi ONITSUKA, Hino-shi (JP); Yoshiyuki KAMATA, Tokyo (JP); Masatoshi SAKURAI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/757,794

(22) Filed: Apr. 9, 2010

(30) Foreign Application Priority Data
Apr. 10, 2009 (JP) 2009-096376

(51) Int. Cl. B29C 43/10

(52) U.S. Cl. 425/405.2

(57) ABSTRACT

According to one embodiment, an imprinting apparatus includes a first mold configured to hold a disk-shaped stamper on which patterns of recesses and protrusions are formed, a second mold configured to hold a disk-shaped substrate to which a resist is applied so that the substrate faces the stamper held by the first mold, and a suction ring which is disposed around the first mold and in which an inner groove and an outer groove are formed to correspond to an outer periphery portion of the stamper held by the first mold, the inner groove being opened to atmosphere and the outer groove being vacuum-suctioned.

### CROSS-REFERENCE TO RELATED APPLICATIONS

This application is based upon and claims the benefit of priority from Japanese Patent Application No. 2009-096376, filed Apr. 10, 2009, the entire contents of which are incorporated herein by reference.

### BACKGROUND

1. Field

One embodiment of the present invention relates to an imprinting apparatus used for transferring a pattern to a resist by imprinting.

2. Description of the Related Art

As a magnetic recording medium capable of improving recording density, a discrete track recording medium is developed. The discrete track recording medium has a structure in which non-recording portions are formed by removing or modifying the magnetic recording layer between recording tracks to suppress interference between the adjacent recording tracks.

The discrete track recording medium is manufactured by using imprinting in view of production efficiency. A method of manufacturing a discrete track recording medium by using imprinting will be schematically described.

A master plate is coated with a resist and then the resist is subjected to electron beam lithography to produce a resist master plate on which patterns of recesses and protrusions are formed. A conductive film is formed on the resist master plate, a nickel (Ni) electroformed film is deposited by electroforming, and the Ni electroformed film is peeled off from the resist master plate to produce a Ni stamper. On the other hand, a magnetic recording layer is formed on a medium substrate and a resist is applied to the magnetic recording layer. Next, an imprinting apparatus comprising first and second molds is prepared, the stamper is held on the first mold and the medium substrate is held on the second mold so that the stamper and the medium substrate are opposed to each other. In this state, the stamper is pressed against the resist on the surface of the medium substrate to transfer the patterns of recesses and protrusions on the stamper to the resist, and then the stamper is peeled off. Then, the magnetic recording layer is etched by using the resist to which the patterns of recesses and protrusions are transferred as a mask to thereby form magnetic patterns such as discrete tracks.

As the imprinting apparatus, there is known an apparatus described in Jpn. Pat. Appln. KOKAI Publication No. 2007-305895, for example. This apparatus is configured to supply gas to the lower surface of the medium substrate to apply imprinting to the medium substrate from the central portion toward the peripheral portion.

However, it is difficult for the conventional imprinting apparatus to peel off the stamper pressed against the resist on the surface of the medium substrate after the imprinting.

FIG. 1 schematically shows a perspective view of a stamper. As shown in FIG. 1, when viewed on the upper surface (patterned surface), it is seen that the stamper 1 is warped so that its central portion is lower and its peripheral portion is higher. A maximum value Hmax of height of the warp measured from a plane shown in a broken line is 1.0 mm, a minimum value Hmin is 0.5 mm, and an average value is 0.75 mm, for example.

With reference to cross-sectional views shown in FIGS. 7A to 7C, a problem that may be caused when a conventional imprinting apparatus is used will be described. As shown in FIG. 7A, the warped stamper 1 is placed on the lower mold 11 and the pin 12 is inserted through their center holes. On the other hand, the medium substrate 2 to which the resist 3 is applied is held by the upper mold 13 and the pin 12 is inserted through their center holes. As shown in FIG. 7B, the lower mold 11 and the upper mold 13 are pressurized uniformly to transfer patterns on the stamper 1 to the resist 3 on the medium substrate 2. As shown in FIG. 7C, the upper mold 13 is lifted to peel the stamper 1 off from the resist 3 on the surface of the medium substrate 2 by utilizing resilience of the stamper 1 for returning to the warped state. However, portions of the stamper 1 may not be peeled off from the resist 3 in some cases by merely utilizing the resilience of the stamper 1. If external forces are applied to the portions that are not peeled to forcibly peel off the portions, transfer defects are caused in the portions. The transfer defects are called “white spot” defects because they look white in an optical surface analyzer (OSA) test image.

FIGS. 8A and 8B show another example of a conventional imprinting apparatus. FIG. 8A is an exploded perspective view of the imprinting apparatus in which portions of the stamper and the medium substrate to be held on the imprinting apparatus are partially sectioned. FIG. 8B is a perspective view of the imprinting apparatus in which portions of the stamper and the medium substrate in a state of being held on the imprinting apparatus are partially sectioned. The pin 12 is inserted through the center hole of the lower mold 11. The suction ring 14 is disposed around the lower mold 11. The groove 15 is formed between the outer peripheral face of the upper portion of the lower mold 11 and the inner peripheral face of the upper portion of the suction ring 14. The groove 15 communicates with the suction path 16 through a connecting hole (not shown) formed in a portion of the bottom face in the groove 15. The suction path 16 is connected to a vacuum pump (not shown). The pin 12 is inserted through the center hole of the stamper 1. On the other hand, the adhesive sheet 4 is stuck to the lower face of the upper mold 13 and the medium substrate 2 is bonded to the adhesive sheet 4.

With reference to cross-sectional views shown in FIGS. 9A to 9D, a problem that may be caused when another example of the conventional imprinting apparatus is used will be described. As shown in FIG. 9A, the warped stamper 1 is placed on the lower mold 11 and the pin 12 is inserted through their center holes. On the other hand, the adhesive sheet 4 is stuck to the lower face of the upper mold 13, the medium substrate 2 is bonded to and held by the adhesive sheet 4, and the pin 12 is inserted through their center holes. As shown in FIG. 9B, by evacuating the groove 15, the lower face of the stamper 1 is stuck to the upper faces of the lower mold 11 and the suction ring 14. At this time, pressure in the clearance between the lower face of the stamper 1 and the upper faces of the lower mold 11 and the suction ring 14 is reduced throughout the faces and therefore the stamper 1 comes into an almost flat state. As shown in FIG. 9C, the lower mold 11 and the upper mold 13 are pressurized uniformly to transfer patterns on the stamper 1 to the resist 3 on the medium substrate 2. As shown in FIG. 9D, the upper mold 13 is lifted. However, if the stamper 1 is in the almost flat state, a large external force is necessary for peeling and it is difficult to peel the stamper 1 off from the resist 3 on the surface of the medium substrate 2. The medium substrate 2 and the adhesive sheet 4 may be peeled off from each other in some cases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of a stamper;

FIG. 2 is an exploded perspective view of an imprinting apparatus according to an embodiment of the present invention in which portions thereof are partially sectioned;

FIGS. 3A, 3B, 3C and 3D are cross-sectional views showing an imprinting method using the imprinting apparatus according to the embodiment of the invention;

FIGS. 4A and 4B show results of simulations of shapes of stampers in the imprinting methods according to the invention and prior art;

FIGS. 5A, 5B, 5C, 5D, 5E and 5F are cross-sectional views showing a method of manufacturing a discrete track recording medium;

FIG. 6 is a block diagram of a magnetic recording apparatus in which the discrete track recording medium is installed;

FIGS. 7A, 7B and 7C are cross-sectional views showing an imprinting method using an example of a conventional imprinting apparatus;

FIGS. 8A and 8B are exploded perspective views of another example of a conventional imprinting apparatus in which portions thereof are partially sectioned; and

FIGS. 9A, 9B, 9C and 9D are cross-sectional views showing an imprinting method using another example of the conventional imprinting apparatus.

### DETAILED DESCRIPTION

Various embodiments according to the invention will be described hereinafter with reference to the accompanying drawings. In general, according to one embodiment of the invention, there is provided an imprinting apparatus comprising: a first mold configured to hold a disk-shaped stamper on which patterns of recesses and protrusions are formed; a second mold configured to hold a disk-shaped substrate to which a resist is applied so that the substrate faces the stamper held by the first mold; and a suction ring which is disposed around the first mold and in which an inner groove and an outer groove are formed to correspond to an outer periphery portion of the stamper held by the first mold, the inner groove being opened to atmosphere and the outer groove being vacuum-sucked.

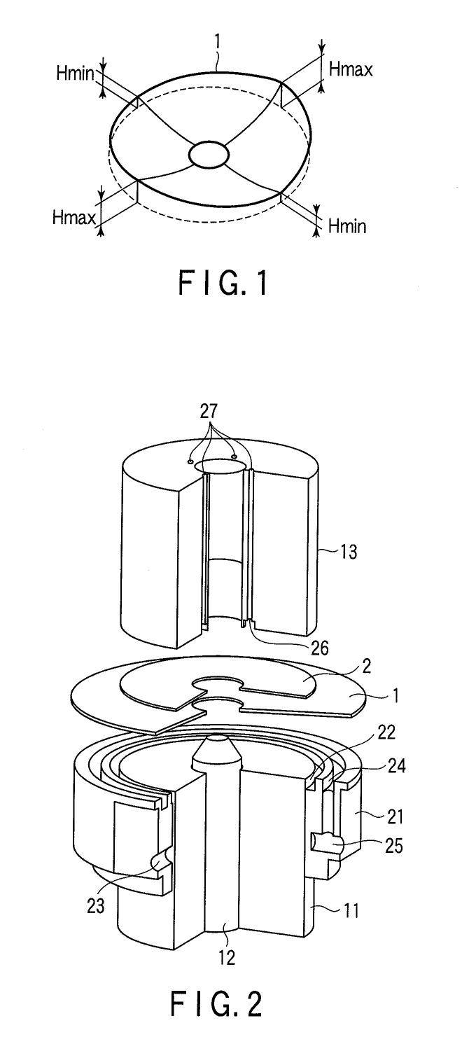

FIG. 2 shows an imprinting apparatus according to an embodiment of the present invention. FIG. 2 is an exploded perspective view in which the stamper and the medium substrate held in the imprinting apparatus are partially sectioned. The pin 12 is inserted through the center hole of the lower mold 11. The suction ring 21 is disposed around the lower mold 11. The inner groove 22 is formed between the outer peripheral face of the upper portion of the lower mold 11 and the inner peripheral face of the upper portion of the suction ring 21. The inner groove 22 communicates with the atmosphere opening path 23 through a connecting hole (not shown) formed in a portion of the bottom face in the inner groove 22. The outer groove 24 is formed in a position outside the inner groove 22 in the upper face of the lower mold 11. The outer groove 24 communicates with the suction path 25 through a connecting hole formed in a portion of the bottom face of the outer groove 24. The suction path 25 is connected to a vacuum pump (not shown). The pin 12 is inserted through the center hole of the stamper 1 that is warped as shown in FIG. 1 and the stamper 1 is placed on the lower mold 11 and the suction ring 21. On the other hand, the groove 26 is formed in the lower face near the inner periphery side of the upper mold 13 and the groove 26 communicates with a plurality of connecting holes 27 vertically passing through the upper mold 13. The plurality of connecting holes 27 are connected to a vacuum pump (not shown). The medium substrate 2 is held by the lower face of the upper mold 13.

Preferably, the width of the inner groove 22 is 0.1 to 2 mm, the width of the outer groove 24 is 0.1 to 3 mm, and the interval between both the grooves is 0.5 to 2 mm. Dimensions of the lower mold 11, the pin 12, and the upper mold 13 are suitably designed depending on the size of the medium substrate 2.

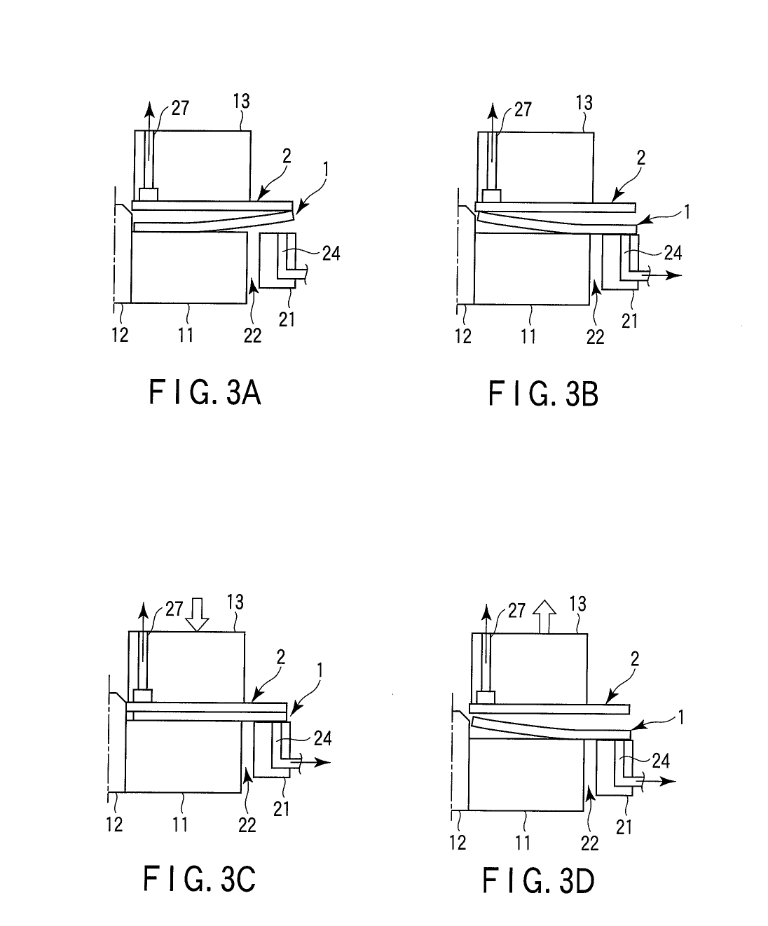

With reference to the cross-sectional views shown in FIGS. 3A to 3D, an imprinting method using the imprinting apparatus according to the embodiment of the invention will be described. As shown in FIG. 3A, the warped stamper 1 is placed on the lower mold 11 and the pin 12 is inserted through their center holes. On the other hand, the inner periphery portion of the back face of the medium substrate 2 is vacuum-sucked and held by the groove 26 in the lower face of the upper mold 13 and the pin 12 is inserted through their center holes. As shown in FIG. 3B, by evacuating the outer groove 24, the peripheral portion of the lower face of the stamper 1 is stuck to the upper face of the suction ring 21. Because the inner side of the inner groove 22 is open to the atmosphere, both the upper face and lower face of the stamper 1 are at atmospheric pressure and the inner periphery portion of the stamper 1 is not stuck to the lower mold 11. At this time, the stamper 1 is warped in an opposite direction to that in FIG. 3A with its inner periphery side higher and the outer periphery side lower. As shown in FIG. 3C, the lower mold 11 and the upper mold 13 are pressurized uniformly to transfer the patterns on the stamper 1 to the resist 3 on the medium substrate 2. As shown in FIG. 3D, if the upper mold 13 is lifted, the stamper 1 tends to return to the state in FIG. 3B. As a result, peeling of the stamper 1 from the resist 3 on the surface of the medium substrate 2 starts from the outer periphery side and continues concentrically toward the inner periphery side. In this case, the stamper 1 finally peels from the innermost periphery of the medium substrate 2. Because the innermost periphery of the medium substrate 2 is not used as the data area, occurrence of poor transfer in this portion does not become a problem.

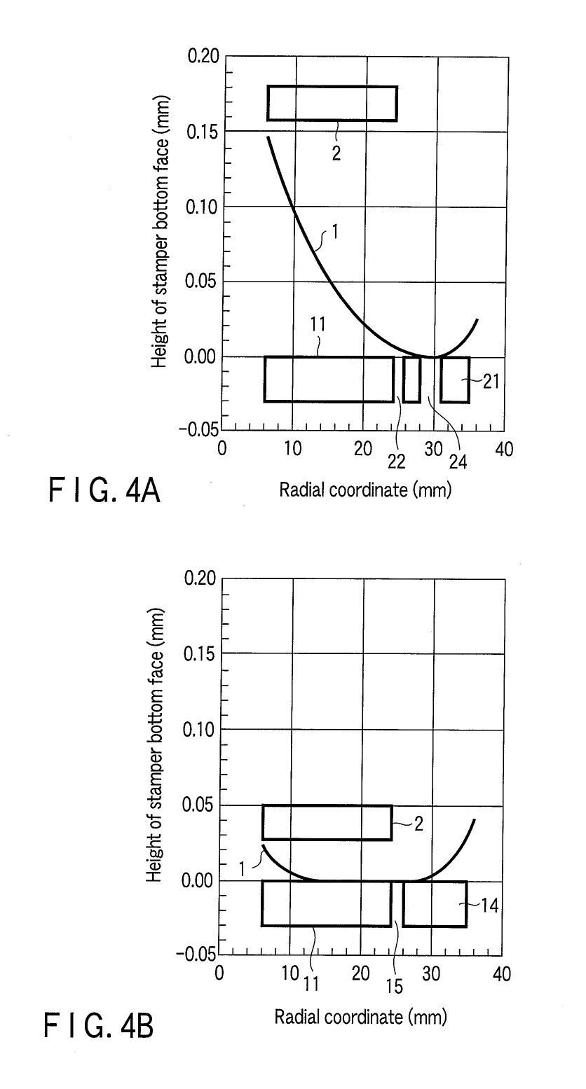

FIGS. 4A and 4B show results of simulations of shapes of the stampers in the imprinting methods according to the invention and prior art. In each drawing, the horizontal axis represents the radial coordinate where the position of 0 mm of the radial coordinate represents the center of the center hole. In each drawing, the vertical axis represents the height of the stamper bottom face.

FIG. 4A shows the state in FIG. 3B of the imprinting apparatus of the invention and the inner periphery side of the stamper is warped about 0.15 mm. If the upper mold is lifted after the imprinting as shown in FIG. 3D, resilience of the inner periphery side of the stamper for returning to the warped state acts and therefore the stamper 1 is successfully peeled off from the resist 3 on the surface of the medium substrate 2.

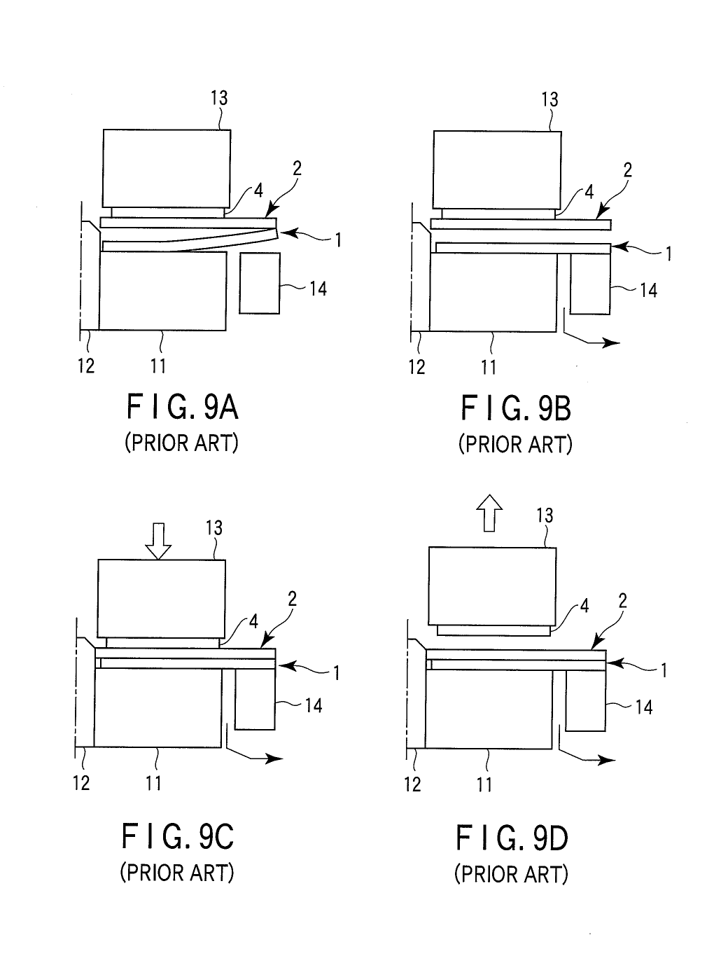

FIG. 4B shows the state in FIG. 9B of the conventional imprinting apparatus and the stamper is in an almost flat state. Therefore, if the upper mold is lifted after the imprinting as shown in FIG. 9D, the resist 3 on the surface of the medium substrate 2 and the stamper 1 are stuck to each other and they are hard to be peeled off.

Although the groove 26 and the connecting holes 27 are formed in the upper mold 13 to vacuum-suck the medium substrate 2 in FIG. 2, an adhesive sheet may be stuck to the upper mold 13 and the medium substrate 2 may be bonded to the adhesive sheet.

FIGS. 3A to 3D show the example in which the inner groove 22 is open to the atmosphere all the time. Alternatively, not only the outer groove 24 but also the inner groove 22 may be vacuum-sucked in the imprinting in FIG. 3B to thereby flatten the stamper 1 and the inner groove 22 may be opened to the atmosphere and then the upper mold 13 may be lifted in the peeling in FIG. 3D to thereby peel the stamper 1 off from the resist 3 on the surface of the medium substrate 2.

To employ this method, the inner groove 22 may be opened to the atmosphere or vacuum-sucked via a three-way valve and the outer groove 24 may be vacuum-sucked in the apparatus in FIG. 2.

If the stamper 1 that is nonuniformly warped as shown in FIG. 1 is held by only pressurization between the lower mold 11 and the upper mold 13, a secondary component of repeatable runout (RRO) may be generated in some cases. On the other hand, if the inner groove 22 is vacuum-sucked to thereby flatten the stamper 1 in the step in FIG. 3B, it is possible to reduce the RRO.

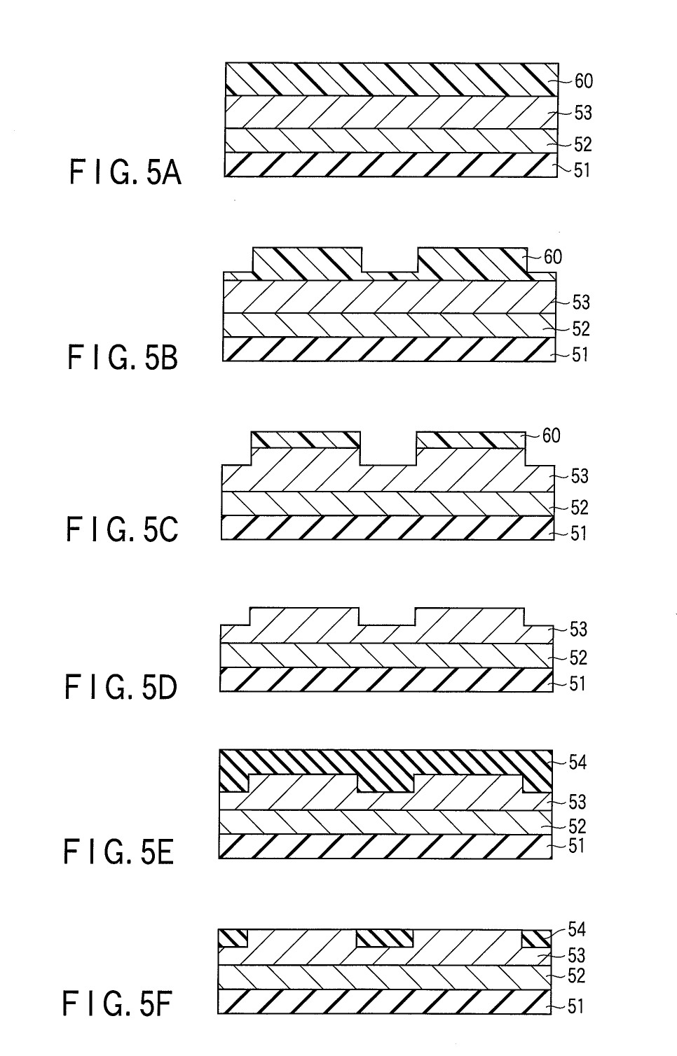

Next, with reference to FIGS. 5A to 5F, a method of manufacturing the magnetic recording medium using the imprinting method according to the invention will be described.

As shown in FIG. 5A, on the substrate 51, the soft magnetic underlayer 52 and the magnetic recording layer 53 are formed and the resist 60 is applied thereto.

Examples of the substrate 51 include a glass substrate, an Al-based alloy substrate, a ceramic substrate, a carbon substrate, a Si single crystal substrate with an oxide surface, and these substrates plated with NiP or the like.

As the soft magnetic underlayer 52, material including Fe, Ni or Co is used. More specifically, an FeCo-based alloy such as FeCo and FeCoV, an FeNi-based alloy such as FeNi, FeNiMo, FeNiCr and FeNiSi, an FeAl-based alloy and an FeSi-based alloy such as FeAl, FeAlSi, FeAlSiCr, FeAlSiTiRu and FeAlO, an FeTa-based alloy such as FeTa, FeTaC and FeTaN, and an FeZr-based alloy such as FeZrN are used.

As the magnetic recording layer 53, magnetic material mainly containing Co, including at least Pt, and also including oxide, and having perpendicular magnetic anisotropy is used, for example. As the oxide, silicon oxide and titanium oxide are suitable.

The resist 60 is used as mask material for forming recesses and protrusions in the magnetic recording layer 53 after transferring the patterns of recesses and protrusions by imprinting as described later. As the resist, a material to which the recesses and protrusions can be transferred by imprinting after applied is used and examples of such material include polymer material, low-molecular organic material, and a liquid Si resist such as spin-on glass (SOG).

In FIG. 5B, transfer of the patterns of recesses and protrusions by imprinting is carried out. A stamper (not shown) on which the desired patterns of recesses and protrusions are formed is pressed evenly against the entire face of the resist 60 to transfer the patterns of recesses and protrusions to the surface of the resist 60. Recesses of the resist 60 formed in this transfer step correspond to recesses formed in the magnetic recording layer 53.

In FIG. 5C, the magnetic recording layer 53 is processed. From the resist 60 obtained in FIG. 5B and having the patterns of recesses and protrusions, resist residues remaining in the recesses are removed to expose the magnetic recording layer 53. Next, ion milling is carried out by using the remaining patterned resist 60 as the mask to thereby form the recesses in the magnetic recording layer 53.

In FIG. 5D, the remaining resist is removed by etching.

In FIG. 5E, a filling layer 54 having a sufficient thickness is deposited by sputtering. As the filling layer 54, nonmagnetic material is used and examples thereof include carbon (C), an oxide such as SiO₂ and Al₂O₃, and metal such as Ti.

In FIG. 5F, the filling layer 54 is etched back until the magnetic recording layer 53 is reached so that the recesses are filled with the filling layer 54 and the surface thereof is flattened.

Then, a protective layer is formed on the surface. The protective layer is intended to prevent corrosion of the perpendicular recording layer and prevent damage to the medium surface when a magnetic head comes in contact with the surface. For the protective layer, material including carbon (C), SiO₂, and ZrO₂ is used, for example. Furthermore, a lubricant is applied to the surface.

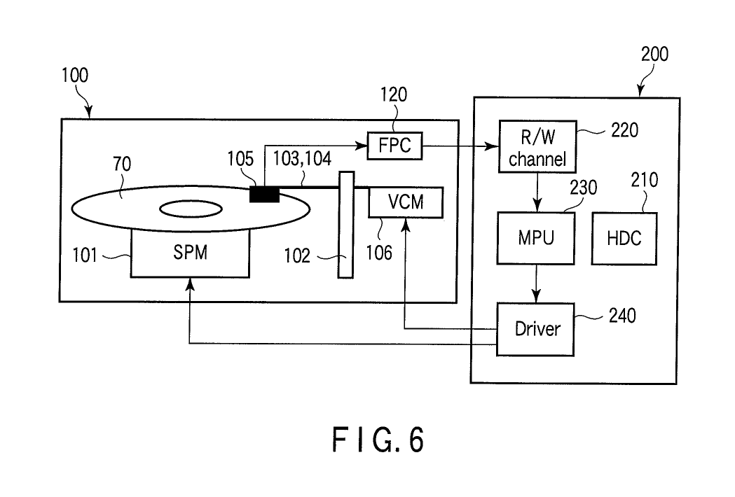

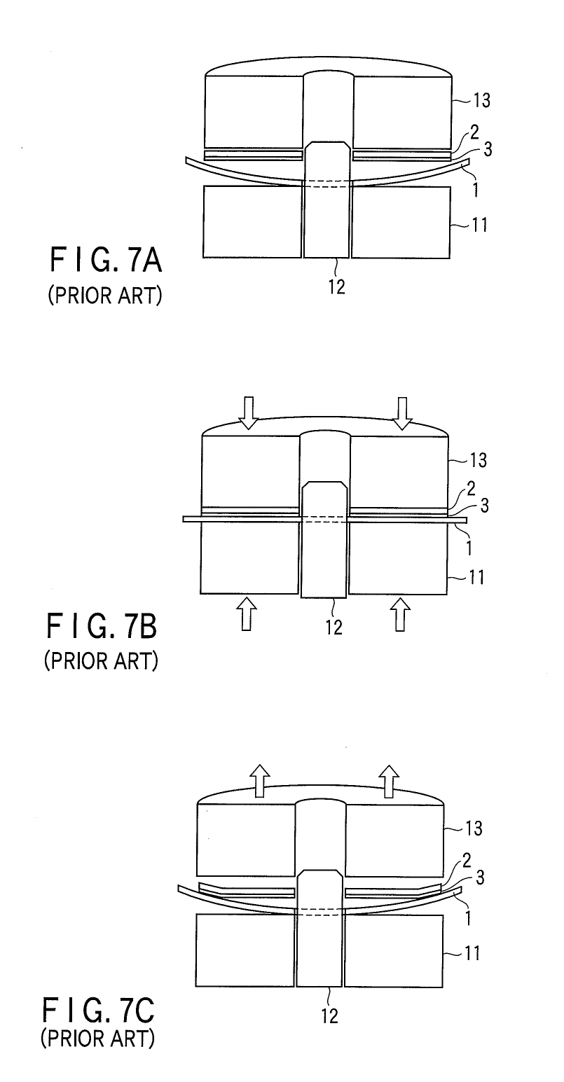

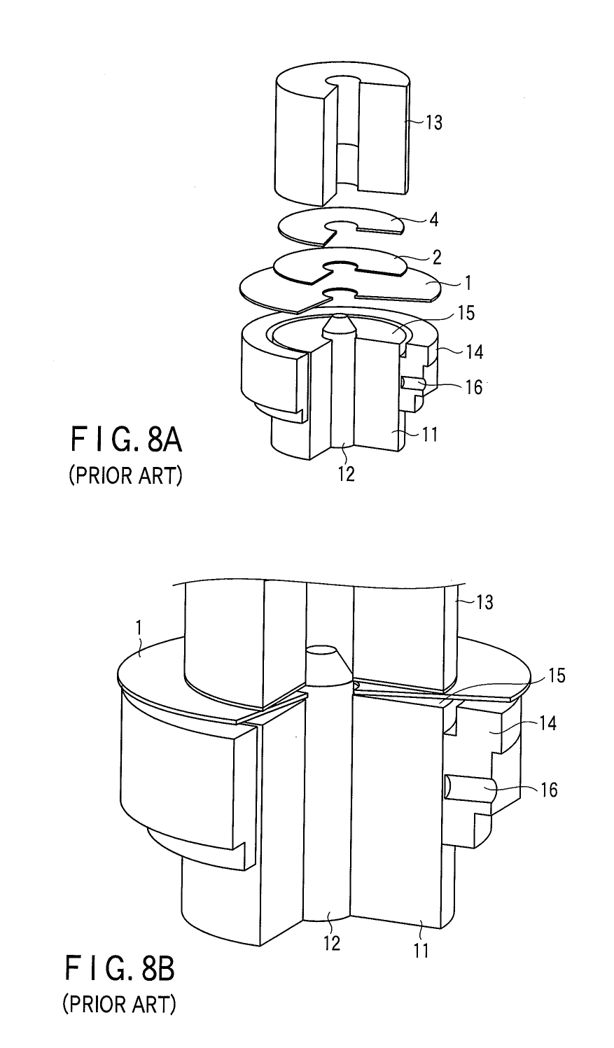

Next, the magnetic recording apparatus mounted with the magnetic recording medium manufactured as described above will be described. FIG. 6 shows a block diagram of the magnetic recording apparatus. Although the head slider is shown only over the upper face of the magnetic recording medium in the drawing, the perpendicular magnetic recording layers having discrete tracks are formed on opposite faces of the magnetic recording medium and the up head and the down head are provided over the upper and lower faces of the magnetic recording medium, respectively.

The disk drive comprises a main body portion called the head disk assembly (HDA) 100 and the printed circuit board (PCB) 200.

The head disk assembly (HDA) 100 comprises the magnetic recording medium (DTR medium) 70, the spindle motor 101 which rotates the magnetic recording medium 70, the actuator arm 103 which turns about the pivot 102, the suspension 104 attached to the tip end of the actuator arm 103, the head slider 105 supported on the suspension 104 and comprising the read head and the write head, the voice coil motor (VCM) 106 which drives the actuator arm 103, a head amplifier (not shown) which amplifies input and output signals to and from the head, and the like. The head amplifier (HIC) is provided on the actuator arm 103 and connected to the printed circuit board (PCB) 200 via the flexible cable (FPC) 120. If the head amplifier (HIC) is provided on the actuator arm 103 as described above, it is possible to effectively reduce noise in head signals. However, the head amplifier (HIC) may be fixed to the HAD main body.

The perpendicular magnetic recording layers are formed on the opposite faces of the magnetic recording medium 70 as described above and the servo areas are formed in an arc shape corresponding to a path of the head on each of the opposite faces. Specifications of the magnetic recording medium meet the outer diameter, the inner diameter, and read and write characteristics adapted to the drive. The radius of the arc formed by the servo area is given as the distance from the pivot to the magnetic head element.

The printed circuit board (PCB) 200 is mounted with four main system LSI. These are the disk controller (HDC) 210, read/write channel IC 220, MPU 230, and motor driver IC 240.

The MPU 230 is a control section of a drive driving system and includes a ROM, a RAM, a CPU, and a logic processing unit for implementing a head positioning control system according to the embodiment. The logic processing unit is an arithmetic processing unit comprising a hardware circuit and performs high-speed arithmetic processing. THe firmware (FW) is stored in the ROM and the MPU controls the drive in accordance with the FW.

The disk controller (HDC) 210 is an interface section in the hard disk, functions as an interface between the disk drive and a host system (e.g., a personal computer), and exchanges information with the MPU, the read/write channel IC, and the motor driver IC to control the entire drive.

The read/write channel IC 220 is a processing unit for the head signals related to read/write and comprises a circuit which switches channels of the head amplifier (HIC) and processes read and write signals.

The motor driver IC 240 is a driver section for the voice coil motor (VCM) 106 and the spindle motor 101, drives and controls the spindle motor 101 so that the spindle motor 101 rotates at constant speed, and actuates a head moving mechanism by providing a VCM operating amount as a current value from the MPU 230 to the VCM 106.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imprinting apparatus comprising:
a first mold configured to hold a disk-shaped stamper comprising patterns of recesses and protrusions;
a second mold configured to hold a disk-shaped substrate comprising a resist thereon so as to allow the substrate to face the stamper held by the first mold; and
a suction ring around the first mold and comprising an inner groove and an outer groove configured to correspond to an outer periphery portion of the stamper held by the first mold, the inner groove being opened to atmosphere and the outer groove being vacuum-suctioned.

2. The apparatus of claim 1, wherein the first mold and the suction ring are combined with each other.

3. The apparatus of claim 1, wherein the second mold comprises a groove configured to to be vacuum-suctioned.

4. The apparatus of claim 3, wherein the groove in the second mold corresponds to an inner periphery portion of the substrate.

5. An imprinting apparatus comprising:
a first mold configured to hold a disk-shaped stamper comprising patterns of recesses and protrusions;
a second mold configured to hold a disk-shaped substrate comprising a resist thereon so as to allow the substrate to face the stamper held by the first mold; and
a suction ring around the first mold and comprising an inner groove and an outer groove configured to correspond to an outer periphery portion of the stamper held by the first mold, the inner groove being opened to atmosphere or vacuum-suctioned through a three-way valve and the outer groove being vacuum-suctioned.

6. The apparatus of claim 5, wherein the inner groove and the outer groove are vacuum-suctioned in imprinting, and the inner groove is opened to the atmosphere and the outer groove is vacuum-suctioned in peeling.
